(19) United States
(12) Patent Application Publication
(10) Pub. No.: US 2006/0194484 A1
(43) Pub. Date: Aug. 31, 2006

(54) Electrical connector with improved terminals

(76) Inventors: Ming Chun Lai, Tucheng City (TW); Chia-Sheng Su, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/066,529

(22) Filed: Feb. 28, 2005

(51) Int. Cl. H01R 4/02

(52) U.S. Cl. 439/874

(57) ABSTRACT

The present invention provides a connector and a conductive terminal. The terminal includes a contact portion, a solder portion and a connecting portion. The solder portion is bent to have a certain radian and has a cable-carrying surface for a cable being placed and soldered thereon. The cable-carrying surface is located above at least half height of the terminal and perpendicular to the contact portion. The contact portion is on the central line of the cable-carrying surface. The connector has an insulation body with a row of terminal holes being defined therein. A row of the terminals are alternatively inverted and vertically inserted into the terminal holes with the solder portions of the terminals extending out of the insulation body in double rows. Therefore, every adjacent two solder portions are staggered up and down to ensure enough space therebetween for facilitating soldering.

### BACKGROUND OF THE INVENTION

1. Field of the Invention

The present invention relates generally to an electrical connector, and more especially, to an electrical connector with improved terminals structured to permit reducing pitch of the terminals assembled in the connector while keeping enough space between every adjacent two solder portions of the terminals, thereby miniaturizing the connector and avoiding interference between such solder portions simultaneously.

2. The Related Art

Cable end connectors are a kind of connector connected to ends of cables by conductors of the cables being soldered to solder portions of terminals of the connectors.

The solder portion of a prior terminal of such electrical connector is flat. Conductors of the cable are placed on the flat solder portion for being soldered thereon. However, the cable usually cannot be soldered firmly and is easy to fall off for the reason that the flat solder portion cannot carry enough soldering tin.

As shown in FIG. 4, another prior electrical connector comprises an insulation member “A” and terminals “B”. A row of terminal passages “A1” is defined in the insulation member “A”. The terminals “B” are horizontally inserted into the terminal passages “A1”. End portions of the terminals “B” extending out from the insulation member “A” are arced solder portions “B1”. Compared to the flat solder portion mentioned above, the arced soldered portion B1 carries more soldering tin. However, the solder portions “B1 of the row terminals “B” are located in a common plane, which occupy a considerable wide width to interfere with downsizing the electrical connector in width. If the width of the electrical connector and pitch of the terminals are reduced for miniaturizing the connector, space between adjacent solder portions is reduced correspondingly thereby increasing the likelihood that the solder portions will accidentally contact each other when being soldered.

FIG. 5 shows more another prior electrical connector. The electrical connector comprises an insulation member “C” and terminals “D”. A row of terminal passages “C1” is defined in the insulation member “C”. A plurality of terminals “D” is vertically inserted into the terminal passages “C1”. End portions of the terminals “C” extending out from the insulation member “C” are n L-shaped soldered portion “D1”. The L-shaped soldered portions “D1” are also located in a common plane. In order to ensure enough space between the solder portions “D1” for soldering, pitch of the terminals “D” can't be reduced, so the electrical connector cannot be compact. Additionally, the L-shaped solder portions “D1” and contact portions to be mated with a complementary connector cannot be positioned in the middle of the insulation member “C” simultaneously, which brings additional troubles, for example, when the contact portions are medially positioned while the L-shaped solder portions “D1” are not, a side of a shielding cover for covering the insulation member “C” will be too close to the solder portions “D1” to result in short circuit.

### SUMMARY OF THE INVENTION

Thus, an object of the present invention is to provide an electrical connector with improved terminals structured to permit reducing pitch of the terminals assembled in the connector for miniaturizing the connector while keeping enough space between every adjacent two solder portions of the terminals for avoiding interference between such solder portions.

To attain the above object, the present invention provides a conductive terminal adapted to connect a cable including a contact portion at one end thereof, a solder portion at the other end thereof, and a connecting portion connecting the contact portion and a side of the solder portion. The solder portion is bent to have a certain radian and provides a cable-carrying surface for the cable being placed and soldered thereon. The solder portion is located above at least half height of the conductive terminal. The cable-carrying surface is perpendicular to the contact portion, and the contact portion is on the central line of the cable-carrying surface.

The present invention also provides an electrical connector assembled with the aforementioned conductive terminals. The electrical connector comprises an insulation body and at least one row of the aforementioned conductive terminals. At least one row of terminal holes is defined in the insulation body. Each row of the conductive terminals is alternatively inverted and vertically inserted into the corresponding terminal holes with the solder portions of the conductive terminals extending out of the insulation body in double rows.

In the present invention, every adjacent two solder portions are arranged staggered up and down to ensure enough space therebetween, thereby permitting pitch of the conductive terminals to be reduced to miniaturize the connector.

Other objects, advantages and novel features of the present invention will become more apparent from the following detailed description when taken in conjunction with the accompanying drawings.

### BRIEF DESCRIPTION OF THE DRAWINGS

FIG. 1 is a perspective view of an electrical connector with improved terminals according to the present invention;

FIG. 2 is an exploded view of the electrical connector as shown in FIG. 1;

FIG. 3 is a perspective view of a conductive terminal according to the present invention;

FIG. 4 is a perspective view of an electrical connector according to a prior art; and

FIG. 5 is a perspective view of another electrical connector according to another prior art.

### DETAILED DESCRIPTION OF THE PREFERRED EMBODIMENT

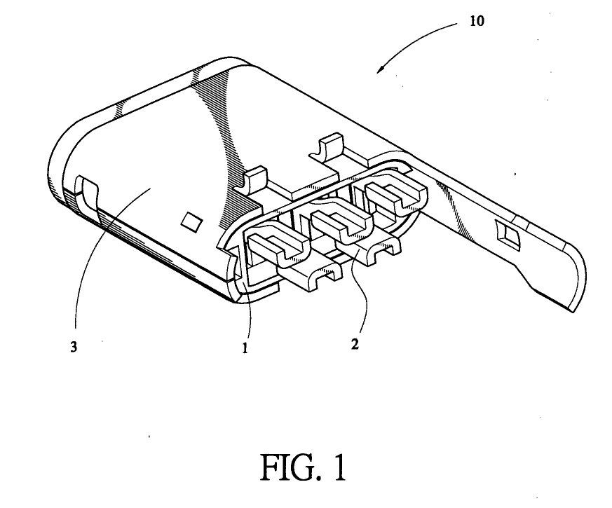

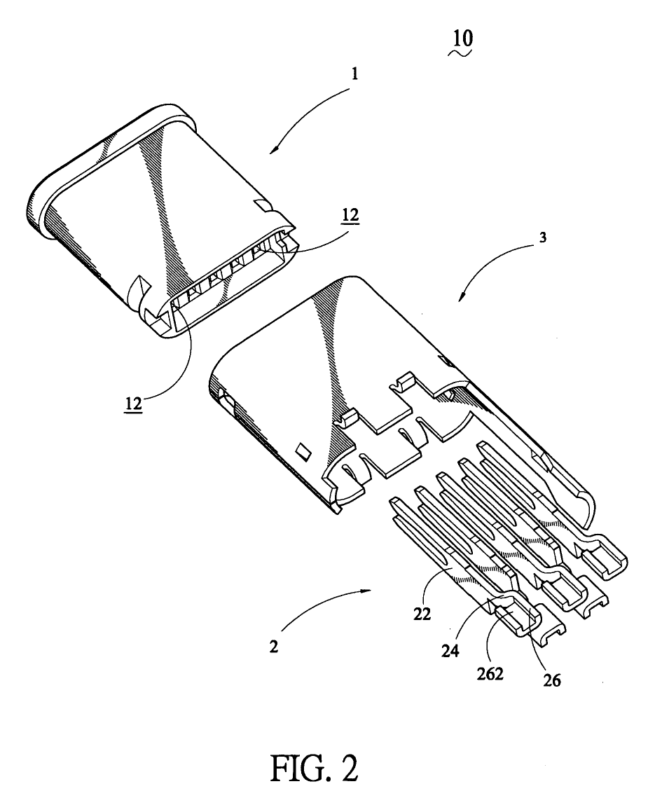

Referring to FIGS. 1 and 2, an electrical connector 10 applied to be connected to an end of a cable comprises an insulation body 1, a plurality of conductive terminals 2 received in the insulation body 1, and a shielding cover 3. A row of terminal holes 12 is defined in the insulation body 1 for the conductive terminals 2 being inserted thereinto.

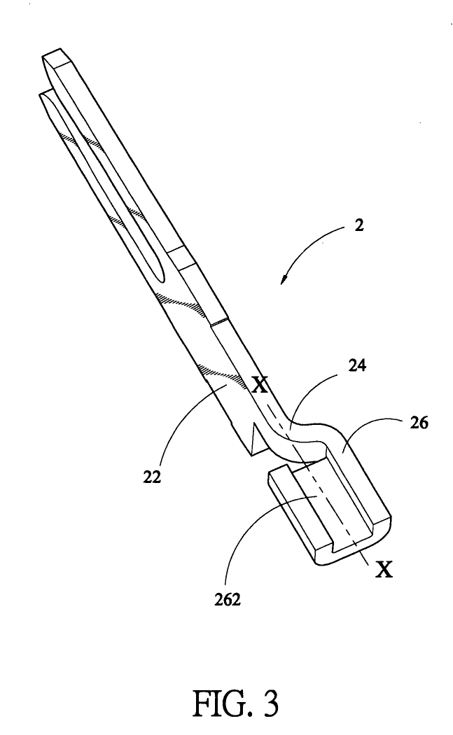

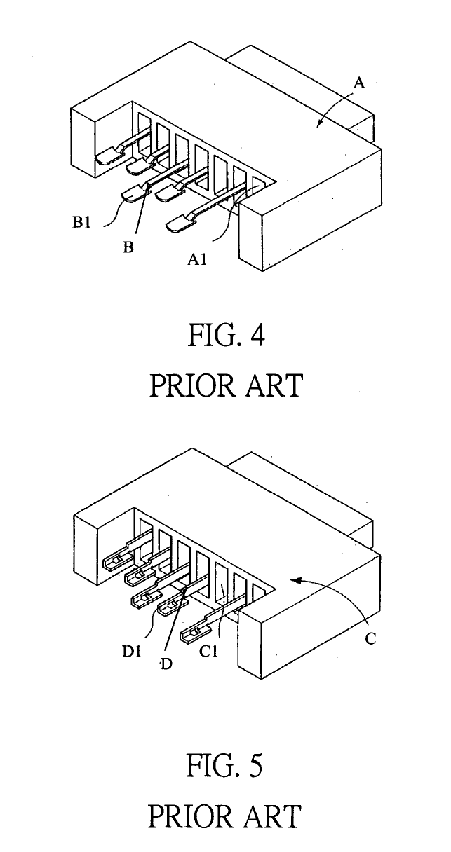

Referring to FIG. 3, the conductive terminal 2 is stamped and formed from a metal strip. Each conductive terminal 2 comprises a contact portion 22, a solder portion 26, and a connecting portion 24 for connecting the contact portion 22 and the solder portion 26. Free end of the contact portion 22 is divided into two legs like a fork-shape. The other end of the contact portion 22 is bent to extend rightwardly to form the connecting portion 24. The solder portion 26 is bent to have a certain radian. The solder portion 26 may have varieties outer shapes, for example, U-shaped, L-shaped, arc-shaped, etc. In the preferred embodiment, the solder portion 26 is U-shaped. The connecting portion 24 connects the contact portion 22 and a side of the solder portion 26. The solder portion 26 is located above at least half height of the conductive terminal 2. The solder portion 26 is further provided with a cable-carrying surface 262 for the cable being placed and soldered stably thereon. The cable-carrying surface 262 is perpendicular to the contact portion 22, and the contact portion 22 is on the central line X-X of the cable-carrying surface 262. Thus, the cable-carrying surface 262 is symmetrical with reference to the contact portion 22.

Now, referring to FIGS. 1 and 2 once again, the insulation body 1 is assembled with the shielding cover 3. A row of conductive terminals 2 are alternatively inverted and vertically inserted into the corresponding terminal holes 12. The solder portions 26 of the conductive terminals 2 are extended outwardly from the terminal holes 12 in double rows. In other words, the rows of the solder portions 26 are double as the rows of the terminal holes 12, since the solder portion 26 is located above at least half height of the conductive terminal 2 as described above. Therefore, one row of the cable-carrying surfaces 262 of the solder portions 26 faces downward while the other row faces upward. Every adjacent two solder portions 26 are staggered in vertical direction and spaced enough distance away. Therefore, the enough space of every adjacent two solder portions 26 avoids interference and prevent from contacting each other. Additionally, when the shielding cover 3 assembled with the insulation body 1, the soldered portions 26 are located in the middle of the insulation body 1. That is to say, the solder portion 26 is the same distance away to one side of the shielding cover 3 as the distance to the other side of the shielding cover 3. Thus, the solder portions 26 avoid resulting short circuit between the shielding cover 3 and the soldered portions 26.

In the present invention, the conductive terminals 2 of the electrical connector 10 are inserted into the row of the terminal holes 12, while the solder portions 26 are extended out of the insulation body in double rows. The two rows arrangement of the solder portions 26 ensures enough space between every adjacent two solder portions 26 and avoids interference between the solder portions 26, thereby permitting pitch of the conductive terminals 2 to be reduced to miniaturize the connector 10. Additionally, the structure of the conductive terminal 2 ensures the terminals 2 being positioned in the middle of the insulation body 1 while the conductive terminals 2 are assembled with the connector 10.

Many variations and modifications may be made to the embodiment of the invention without departing substantially from the spirit and principles of the invention. All such modifications and variations are intended to be included herein within the scope of the present invention.

1. An electrical connector adapted to be connected to an end of a cable, comprising:
an insulation body, at least one row of longitudinally extended terminal holes being defined in the insulation body; and
at least one row of conductive terminals respectively received in said terminal holes, each conductive terminal being stamped and formed from a metal strip, the conductive terminal comprising a planar contact portion oriented in a first plane with a centrally disposed axis extending in a longitudinal directions a solder portion and a connecting portion connecting the contact portion and a side of the solder portion, the solder portion being bent to have a certain radius and being disposed laterally of said connecting portion, said solder portion having a cable-carrying surface extending in said longitudinal direction and being coaxial with said axis in a second plane for the cable to be placed and soldered thereon, said second plane being perpendicular to said first plane, said solder portion being displaced from said axis in said first plane, each of said conductive terminals in said at least one row being alternately inverted and inserted into the corresponding terminal holes with said first plane oriented vertically and the solder portions of said conductive terminals extending out of the insulation body in at least one double row.

2. The electrical connector as claimed in claim 1, wherein each said solder portion is U-shaped.

3. The electrical connector as claimed in claim 1, wherein each said solder portion is L-shaped.

4. The electrical connector as claimed in claim 1, wherein each said solder portion is arced.

5. A conductive terminal adapted to connect a cable, comprising:
a planar contact portion at one end thereof oriented in a first plane with a centrally disposed axis extending in a longitudinal direction;
a solder portion at the other end thereof, the solder portion being bent to have a certain radius and having a cable-carrying surface extending in said longitudinal direction and being coaxial with said axis in a second ilane for the cable to be placed and soldered thereon, said second plane being transverse to said first plane; and
a connecting portion connecting said contact portion and a side of said solder portion, said solder portion being disposed laterally of said connecting portion, said solder portion being displaced from said axis in said first plane.

6. The conductive terminal as claimed in claim 5, wherein said solder portion is U-shaped.

7. The conductive terminal as claimed in claim 5, wherein said solder portion is L-shaped.

8. The conductive terminal as claimed in claim 5, wherein said solder portion is arced.
